(19) United States
(12) Patent Application Publication
(10) Pub. No.: US 2020/0019788 A1
(43) Pub. Date: Jan. 16, 2020

(54) COMPUTER SYSTEM, RESOURCE ARRANGEMENT METHOD THEREOF AND IMAGE RECOGNITION METHOD THEREOF

(71) Applicant: Coretronic Corporation, Hsin-Chu (TW)

(72) Inventor: Ying-Hung Lo, Hsin-Chu (TW)

(73) Assignee: Coretronic Corporation, Hsin-Chu (TW)

(21) Appl. No.: 16/425,972

(22) Filed: May 30, 2019

(30) Foreign Application Priority Data
Jul. 13, 2018 (CN) 201810767311.9

(51) Int. Cl. G06K 9/00; H04N 5/765; H04N 9/87; H04N 5/91; G06T 7/20; H04N 7/18

(52) U.S. Cl. CPC G06K 9/00771; G06K 9/00335; H04N 5/765; H04N 9/87; H04N 5/91; G06T 2207/30232; G06T 7/20; H04N 7/181; G06T 2207/30196; G06T 2207/30241; G06K 9/00362

(57) ABSTRACT

A computer system, a resource arrangement method thereof, and an image recognition method thereof are provided. In the method, images captured by multiple image capturing apparatuses are obtained. Whether a warning object exists in the images of the image capturing apparatuses is recognized respectively through multiple recognition operations, and each of the recognition operations occupies a part of a system loading of the computer system. If the warning object is recognized in one of the images, the system loading used by the recognition operations is modified, and a person associated with the warning object in the images is determined. The invention dynamically modifies the loading of the computer system and provides a more practical recognition method to enable the computer system to process the recognition operations in real time.

### CROSS-REFERENCE TO RELATED APPLICATION

This application claims the priority benefit of China application serial no. 201810767311.9, filed on Jul. 13, 2018. The entirety of the above-mentioned patent application is hereby incorporated by reference herein and made a part of this specification.

### BACKGROUND OF THE DISCLOSURE

### Field of the Disclosure

The disclosure relates to a security protection system and technique, and in particular, to a computer system, a resource arrangement method thereof, and an image recognition method thereof.

### Description of Related Art

For security protection, some stores or households are installed with closed-circuit television (CCTV) monitoring systems to monitor specific areas. Although a user can watch the monitored image in real time, manual monitoring incurs high costs and human negligence is inevitable.

As technology advances, image recognition techniques have become well developed and have been gradually introduced into the monitoring system. For example, FIG. 1 is a schematic diagram illustrating image recognition in related art.

Referring to FIG. 1, a person and goods in an image I are respectively recognized based on image recognition techniques. Since image recognition techniques have higher demands for computational resources of a computer, the local side (e.g., a personal computer (PC) or a notebook computer (NB)) generally cannot recognize many monitored images or many monitored targets in real time. Therefore, the current monitoring system may transmit the monitored images to the remote side (e.g., a cloud server) to perform recognition on the monitored images through the higher computational capability of the cloud server. However, due to issues such as the network connection and the response rate, it is possible that the recognition result of the cloud server cannot be fed back to the user in real time to enable the user to make a corresponding response. Accordingly, there is still room for improvement in the current recognition techniques for monitoring.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the disclosure were acknowledged by a person of ordinary skill in the art.

### SUMMARY OF THE DISCLOSURE

The disclosure provides a computer system, a resource arrangement method thereof, and an image recognition method thereof that dynamically modifies the loading of the computer system and provides a more practical recognition method to enable the computer system to process recognition operations in real time.

Other purposes and advantages of the disclosure may be further understood according to the technical features disclosed herein.

To achieve one, part, or all of the foregoing purposes or other purposes, an embodiment of the disclosure provides a resource arrangement method for a computer system, and the method includes the following steps. Images captured by a plurality of image capturing apparatuses are obtained. Whether a warning object exists in the images of the image capturing apparatuses is recognized respectively through multiple recognition operations, wherein each of the recognition operations occupies a part of a system loading of the computer system. If the warning object is recognized in at least one of the images, the system loading used by the recognition operations is modified.

To achieve one, part, or all of the foregoing purposes or other purposes, an embodiment of the disclosure provides a computer system including an input apparatus, a storage apparatus, an image processor, and a main processor. The input apparatus obtains multiple images captured by multiple image capturing apparatuses. The storage apparatus records the images of the image capturing apparatuses and multiple modules. The image processor operates an inference engine. The main processor is coupled to the input apparatus, the storage apparatus, and the image processor and accesses and loads the modules recorded in the storage apparatus. The modules include multiple basic recognition modules and a load balancing module. The basic recognition modules perform multiple recognition operations through the inference engine to respectively recognize whether a warning object exists in the images of the image capturing apparatuses, wherein each of the recognition operations occupies a part of a system loading of the computer system. If the warning object is recognized in the images, the load balancing module modifies the system loading used by the recognition operations.

To achieve one, part, or all of the foregoing purposes or other purposes, an embodiment of the disclosure provides an image recognition method including the following steps. Multiple images, which are consecutively captured, are obtained. Whether a warning object exists in the images is recognized. If the warning object exists in the images, a person associated with the warning object in the images is determined. An interaction behavior between the person and the warning object in the images is determined according to a temporal relationship of the images to determine a scenario corresponding to the images.

To achieve one, part, or all of the foregoing purposes or other purposes, an embodiment of the disclosure provides a computer system for image recognition including an input apparatus, a storage apparatus, an image processor, and a main processor. The input apparatus obtains multiple consecutively captured images. The storage apparatus records the images and multiple modules. The image processor operates an inference engine. The main processor is coupled to the input apparatus, the storage apparatus, and the image processor and accesses and loads the modules recorded in the storage apparatus. The modules include a basic recognition module and an advanced recognition module. The basic recognition module recognizes whether a warning object exists in the images through the inference engine. If the warning object exists in the images, the advanced recognition module determines a person associated with the warning object in the images through the inference engine, and determines an interaction behavior between the person and the warning object in the images according to a temporal relationship of the images to determine a scenario corresponding to the images.

Based on the above, in the embodiments of the disclosure, the system loading used by the recognition operations is evenly allocated in the normal state. After the warning object is detected in the images, the computer system is switched to the emergency state, and the system loading is allocated to the advanced recognition operation to ensure that the recognition result can all be obtained in real time in the general recognition operations specific to the warning object and the advanced recognition operation specific to the specific scenario without affecting the recognition accuracy. On the other hand, with respect to the recognition of the specific scenario, the embodiments of the disclosure take into account the interaction behavior formed of the person and the warning object in the images of different times to improve reliability of scenario recognition.

Other objectives, features and advantages of the disclosure will be further understood from the further technological features disclosed by the embodiments of the disclosure wherein there are shown and described preferred embodiments of this disclosure, simply by way of illustration of modes best suited to carry out the disclosure.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a schematic diagram illustrating image recognition in related art.

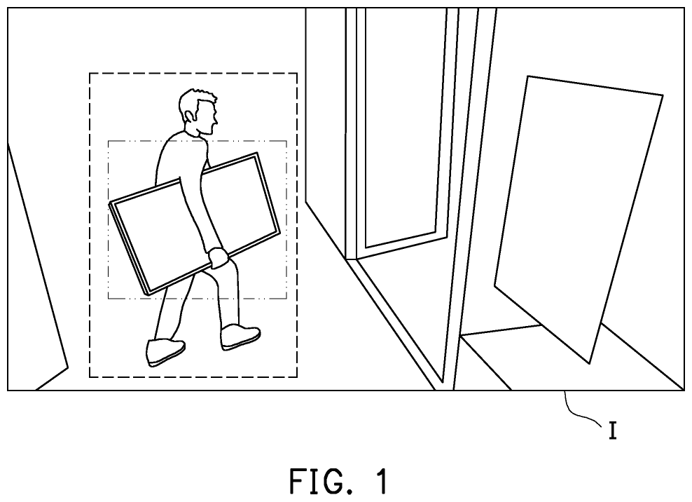

FIG. 2 is an element block diagram illustrating a security protection system according to an embodiment of the disclosure.

FIG. 3 is a flowchart illustrating a resource arrangement method according to an embodiment of the disclosure.

FIG. 4 shows system loading allocation in a normal state according to an embodiment of the disclosure.

FIG. 5 is a flowchart illustrating an image recognition method according to an embodiment of the disclosure.

FIG. 6 shows system loading allocation in an emergency state according to an embodiment of the disclosure.

### DESCRIPTION OF THE EMBODIMENTS

It is to be understood that other embodiment may be utilized and structural changes may be made without departing from the scope of the disclosure. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings.

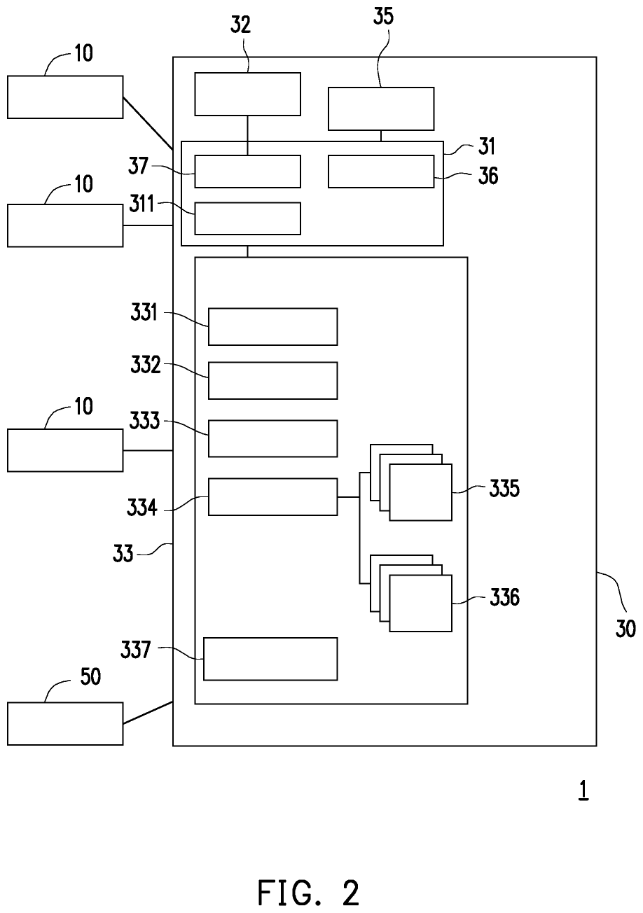

FIG. 2 is an element block diagram illustrating a security protection system 1 according to an embodiment of the disclosure. Referring to FIG. 2, the security protection system 1 includes multiple image capturing apparatuses 10, a computer system 30, and a monitoring platform 50.

Each image capturing apparatus 10 is an apparatus (e.g., a camera, a video recorder, etc.) that can capture an image, and each image capturing apparatus 10 includes components such as a lens, an image sensor, etc. Each image capturing apparatus 10 may perform an image capturing operation on a specific area in an environment.

The computer system 30 is, for example, a desktop computer, a notebook computer, a workstation, or a server of any of various types. The computer system 30 at least includes a processing system 31, an input apparatus 32, a storage apparatus 33, and a warning apparatus 35 but is not limited thereto. The processing system 31 includes an image processor 36, a main processor 37, and an artificial intelligence (AI) inference engine 311.

The image processor 36 may be a processor such as a graphic processing unit (GPU), an AI chip (e.g., a tensor processing unit (TPU), neural processing unit (NPU), a vision processing unit (VPU), etc.), an application-specific integrated circuit (ASIC), or a field programmable gate array (FPGA). The image processor 36 is designed to serve as a neural computation engine configured to provide computational capability/capacity and operate the AI inference engine 311. Specifically, the inference engine 311 is implemented as firmware. In the embodiment, the inference engine 311 determines a decision result of input data by using a neural network model or classifier trained based on machine learning. For example, a recognition operation is performed to determine whether a person or an object exists in an input image. It is noted that the computational capability of the image processor 36 enables the inference engine 311 to determine the decision result of the input data. In other embodiments, the image processor 36 may also adopt operations of other image recognition algorithm techniques and the disclosure is not limited thereto.

The input apparatus 32 may be a wired transmission interface (e.g., Ethernet, optical fibers, coaxial cables, etc.) or a wireless transmission interface (e.g., Wi-Fi, the 4G or later-generation mobile network, etc.) of any type. It is noted that the image capturing apparatus 10 also includes a transmission interface identical to or compatible with the transmission interface of the input apparatus 32, so that the input apparatus 32 can obtain one or multiple consecutive images captured by the image capturing apparatus 10.

The storage apparatus 33 may be a fixed or movable random access memory (RAM), read only memory (ROM), flash memory, hard disk drive (HDD), a solid-state drive (SSD) in any form or a similar apparatus. The storage apparatus 33 is configured to record program codes and software modules (e.g., an image reception module 331, a data modification module 332, a load balancing module 333, a loading module 334, several basic recognition modules 335, several advanced recognition modules 336, an event feedback module 337, etc.). Moreover, the storage apparatus 33 is configured to record the images of the image capturing apparatuses 10 and other data or files. The details will be described in the embodiments below.

The warning apparatus 35 may be a display (e.g., a liquid crystal display (LCD), a light-emitting diode (LED) display, etc.), a loudspeaker (i.e., a speaker), a communication transceiver (supporting the mobile network, Ethernet, etc., for example), or a combination of these apparatuses.

The processing system 31 is coupled to the input apparatus 32 and the storage apparatus 33, and the processing system 31 can access and load the software modules recorded in the storage apparatus 33. The main processor 37 of the processing system 31 is coupled to the image processor 36, the input apparatus 32, the storage apparatus 33, and the warning apparatus 35. The main processor 37 may be a central processing unit (CPU), a micro-controller, a programmable controller, an application-specific integrated circuit, a similar apparatus, or a combination of these apparatuses. In the embodiment, the main processor 37 may access and load the software modules (e.g., the image reception module 331, the data modification module 332, the load balancing module 333, the loading module 334, the several basic recognition modules 335, the several advanced recognition modules 336, the event feedback module 337, etc.) recorded in the storage apparatuses 33.

The monitoring platform 50 is, for example, a desktop computer, a notebook computer, a workstation, or a server of any of various types. The monitoring platform 50 may be located in a security room, a security company, a police station, or another security unit located in the region. If the warning apparatus 35 is a communication transceiver, the monitoring platform 50 also includes a receiver of the same or compatible communication technique to receive messages transmitted by the warning apparatus 35.

To provide a further understanding of the operation process of the embodiments of the disclosure, a number of embodiments are provided below to detail the processes of computational resource arrangement and image recognition in the embodiments of the disclosure. In the description below, the apparatuses, elements, and modules in the security protection system will be referred to describe the method of the embodiments of the disclosure. The processes of the method may be adjusted according to the actual implementation setting and are not limited thereto.

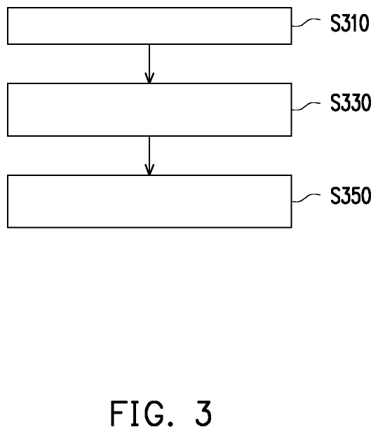

FIG. 3 is a flowchart illustrating a resource arrangement method according to an embodiment of the disclosure. Referring to FIG. 3, the image reception module 331 obtains the images (which may be analog or digital videos) captured by the image capturing apparatuses 10 through the input apparatus 32 (step S310). Specifically, the processing system 31 loads the image reception module 331, and the image reception module 331 obtains the images captured by the image capturing apparatuses 10 through the input apparatus 32. Next, according to the number of the image capturing apparatuses 10, the main processor 37 of the processing system 31 operates the same number of the basic recognition modules 335. The basic recognition modules 335 perform recognition operations through the inference engine 311 to respectively recognize whether a warning object exists in the captured images provided by the image capturing apparatuses 10 (step S330). The warning object may be a hazardous object (e.g., a gun and a knife), goods, money, etc. The types and numbers may be adjusted according to the actual requirements of a user. The inference engine 311 determines on all objects in the images by using the classifier or neural network model specific to the warning object to obtain a recognition result of whether the warning object exists.

It is noted that each recognition operation occupies a part of a system loading (e.g., the computational resources of the main processor 37, the storage apparatus 33, and/or the image processor 36) of the computer system 30. The resources are defined as the resources for computing data. The event feedback module 337 switches the computer system 30 to one of a normal state and an emergency state through the load balancing module 333 according to the recognition result of the inference engine 311. If the recognition result is that the basic recognition modules 335 do not recognize the warning object in any of the images captured by the image capturing apparatuses 10, the event feedback module 337 maintains or switches to the normal state, to have the load balancing module 333 equally allocate the system loading (computational capability) of the computer system 30 to the recognition operations. Here, equal allocation means that the system loading occupied by each recognition operation is substantially equal. It is noted that the load balancing module 333 equally allocates the system loading according to the computational resources required for each recognition operation. In some cases (for example, when more objects exist in the image or the environment is dark), the system loading allocated to some recognition operations may be different.

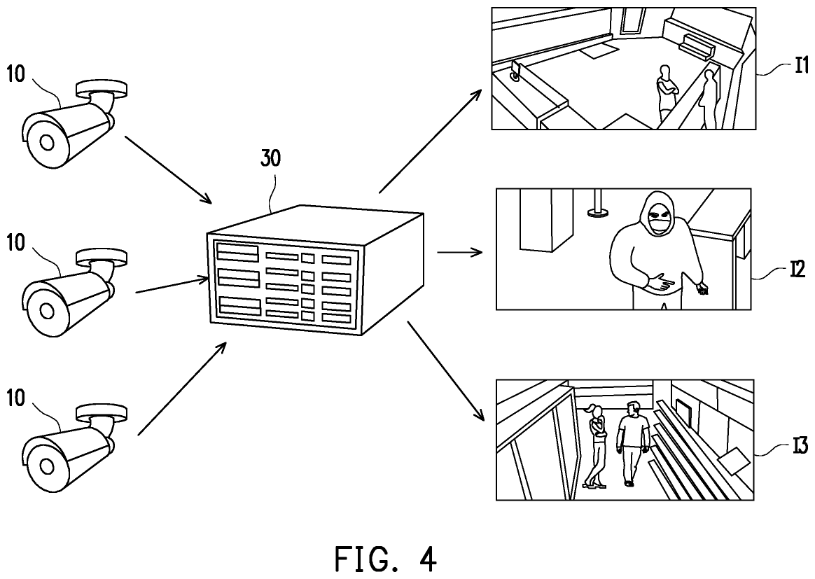

For example, FIG. 4 shows system loading allocation in the normal state according to an embodiment of the disclosure. Referring to FIG. 4, it is assumed that there are three image capturing apparatuses 10, and the right side of the drawing represents images I1 to I3 captured by the image capturing apparatuses 10 and received by the computer system 30. The inference engine 311 of the processing system 31 recognizes whether the warning object exists in the three images I1 to I3, respectively. If the warning object does not exist in any of the images I1 to I3, the system loading occupied by each recognition operation is all about 33%.

On the other hand, if any of the basic recognition modules 335 recognizes the warning object in one of the images, the load balancing module 333 modifies the system loading occupied by the recognition operations (step S350). Specifically, if the recognition result is merely based on the warning object, excessive unnecessary reporting may occur (for example, where the warning object is a gun, a scenario of a patrolman carrying a gun occurs in the image; or where the warning object is goods (e.g., a knife), a scenario of a clerk moving the goods occurs in the image; it is actually not necessary to report such scenarios to the user). Therefore, in the embodiments of the disclosure, the scenario (including the person, the event, the time, the location, the object, etc.) corresponding to the warning object is further analyzed to correctly obtain the recognition result that needs reporting. Since the basic recognition modules 335 only recognize the warning object, the advanced recognition modules 336 are further included in the embodiments of the disclosure. An advanced recognition operation specific to the scenario is performed through the advanced recognition module 336 (namely, the scenario (story) content presented in the image is further analyzed through the advanced recognition module 336).

The advanced recognition operation requires analysis on scenario factors including the person, the event, the location, the time, etc. Therefore, the advanced recognition module 336 of the advanced recognition operation uses more classifiers or neural network models and consumes more system resources than the basic recognition module 335. To enable the advanced recognition operation to operate normally (e.g., providing the recognition result in real time), after the event feedback module 337 switches the computer system 30 to the emergency state according to the recognition result of the inference engine 311, in the emergency state, the load balancing module 333 determines the images in which the warning object is not recognized as general images and reduces the system loading occupied by the recognition operations corresponding to the general images.

Many methods are available to reduce the system loading. In an embodiment, the load balancing module 333 controls the data modification module 332, and the data modification module 332 reduces the image processing rate of the recognition operations corresponding to the general images. For example, with respect to one image capturing apparatus 10, the image processing rate of the recognition operation in the normal state is processing 30 frames of image per second. For example, in the emergency state, the warning object does not exist in the image I1 captured by the image capturing apparatus 10. Therefore, the image reception module 331 receives 30 frames per second, and the data modification module 332 obtains 10 frames from the 30 frames per second, such that the basic recognition module 335 performs recognition only on the 10 selected frames per second. Since the number of frames of image to be recognized per second is reduced, the system resources occupied by the recognition operation are also reduced.

In another embodiment, the data modification module 332 reduces the image resolution of the general images in the corresponding recognition operation processing. For example, with respect to one image capturing apparatus 10, the recognition operation recognizes the general image having the resolution of 1920×1080 in the normal state. In the emergency state, the warning object does not exist in the image I1 captured by the image capturing apparatus 10. The data modification module 332 reduces the resolution of the general image to 720×480, such that the basic recognition module 335 performs recognition only on the general image having the resolution of 720×480. Since the number of pixels to be recognized per frame is reduced, the system resources occupied by the recognition operation are also reduced.

On the other hand, in the emergency state, the load balancing module 333 determines the image in which the warning object is recognized as a focus image and provides the system loading reduced from the general images (e.g., the system resources spared by reducing the image processing rate or the resolution) to the advanced recognition operation. Accordingly, the advanced recognition module 336 can have sufficient system resources to determine the relationship between the warning object and the person, the location, or the time in the focus image through the advanced recognition operation.

It is noted that, if the warning object is recognized in the images captured by two or more image capturing apparatuses 10, the main processor 37 operates the same number of the advanced recognition modules 336 to respectively process the advanced recognition operations to provide the recognition result in real time. The amount of the system resources reduced from the recognition operations of the general images is determined by the load balancing module 333 according to the amount of resources required for the advanced recognition operations to provide the recognition result in real time. Moreover, in the booting process of the computer system 30, the loading module 334 may load the basic recognition modules 335 and the advanced recognition module 336 first. When recognition is not performed through the inference engine 311, the basic recognition modules 335 and the advanced recognition module 336 almost do not consume the overall computational resources of the computer system 30. Since the software modules 335 and 336 are loaded in advance, they can be executed in time when the recognition operations or the advanced recognition operations are required, which thereby improves the response rate.

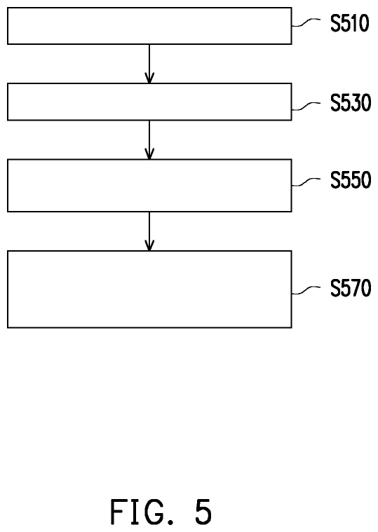

Image recognition will be detailed in the description below. FIG. 5 is a flowchart illustrating an image recognition method according to an embodiment of the disclosure. Referring to FIG. 5, reference may be made to the embodiment of steps S310 and S330 of FIG. 3 for the detailed description of steps S510 and S530, which shall not be repeated here. It is noted that, for ease of illustration, the description below concerns analysis on multiple images consecutively captured by one of the image capturing apparatuses 10. Other embodiments involving images captured by more image capturing apparatuses 10 may be analogously inferred.

If the warning object exists in the images, the basic recognition module 335 still continues to recognize the warning object, and the advanced recognition module 336 determines a person associated with the warning object in the image (i.e., the focus image) (step S550). In the embodiment, the advanced recognition module 336 determines whether a person exists in the images through the inference engine 311, and then determines whether the person matches a trusted person by using a specific classifier or neural network model. The trusted person includes, for example, a clerk, a policeman, a security guard, etc. and may be adjusted according to the actual requirements. If the person does not match the trusted person, the advanced recognition module 336 determines the person as a warning person.

Next, the advanced recognition module 336 determines the interaction behavior between the person and the warning object in the images according to the temporal relationship of the images to determine the scenario corresponding to the images (step S570). Specifically, the interaction behavior includes, for example, actions or behaviors such as the person moving with the warning object in hand, the person obtaining the warning object from a shelf, etc. However, it may be unnecessary to report some scenarios in which the person and the warning object co-exist in the images to the user (for example, the warning object is a gun, the scenario in which a customer obtains a toy gun from the shelf occurs in the image; or where the warning object is goods, the scenario in which a customer moves in the store with goods in hand occurs in the image). Therefore, in the embodiments of the disclosure, the advanced recognition module 336 determines the movement path of the warning object along with the person according to the temporal relationship of the images. The advanced recognition module 336 determines the positions of the person in the different images according to the temporal relationship (sequence) and connects the positions to form the movement path. The advanced recognition module 336 then determines whether the movement path in the scenario matches a reporting behavior (e.g., the person holding the warning object directly moving from the gate of the store to the counter; or the person carrying goods in a cart and moving directly from the shelf to the gate of the store, which may be adjusted according to the actual requirements). In other words, the advanced recognition module 336 further analyzes the event formed of the person and the warning object as time elapses.

If the movement path matches the reporting behavior, the advanced recognition module 336 reports the scenario (i.e., the recognition result of the advanced recognition operation) through the warning apparatus 35. Many methods are available to report the scenario. For example, the warning apparatus 35 may generate a warning sound, display a warning mark in the image, or issue a warning message to the external monitoring platform 50 (which may be located at a security or police unit).

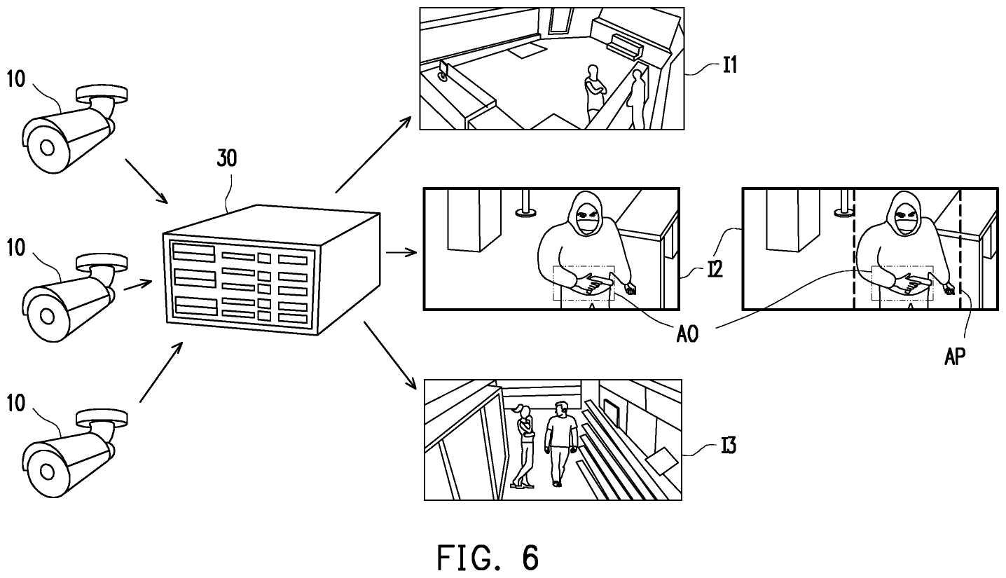

For example, FIG. 6 shows system loading allocation in the emergency state according to an embodiment of the disclosure. Referring to FIG. 6, it is assumed that there are three image capturing apparatuses 10, and the right side of the drawing represents images I1 to I3 captured by the image capturing apparatuses 10 received by the computer system 30. After the inference engine 311 recognizes a warning object AO in the image I2, compared to the embodiment of FIG. 4, in the emergency state, the system loading occupied by the recognition operations (i.e., specific to the images I1 and I3) in which the warning object AO is not recognized is reduced to 15%. In addition, the recognition operation and the advanced recognition operation specific to the image I2 are allocated with 70% of the system loading (the recognition operation of the image I2 is maintained, but the main processor 37 additionally performs the advanced recognition operation specific to the image I2 (shown as the rightmost image in the drawing)). Accordingly, the advanced recognition module 336 can have the system resources to further determine whether an associated person AP exists and the interaction behavior between the person AP and the warning object AO. It is assumed that the advanced recognition module 336 determines that the current scenario is that the person AP (the warning person) in the image I2 holds the warning object AO (the gun) and moves from the gate of the store to the counter. At this time, the advanced recognition module 336 can report the scenario through the warning apparatus 35.

On the other hands, since all of the recognition operations continue to be performed, in the emergency state, if the recognition result according to the recognition operations (or the inference engine 311) shows that no warning object is recognized, the event feedback module 337 switches the computer system 30 to the normal state and stops performing the advanced recognition operation. Moreover, the load balancing module 333 equally allocates all of the system loading to the recognition operations of the basic recognition modules 335. In addition, in the emergency state, if the warning object is also recognized in other images, the event feedback module 337 maintains the emergency state, and the load balancing module 333 may further reduce the system loading of the recognition operations corresponding to the general images or reduce the system loading previously provided to the operated advanced recognition operation. Therefore, another advanced recognition module 336 can have the system resources to provide the recognition result in real time.

In summary of the above, considering that the computational capability of the computer system 30 is insufficient, in the embodiments of the disclosure, the system loading occupied by the recognition operations and the advanced recognition operation may be dynamically modified according to the recognition result of the recognition operations. In the normal state, the recognition operations concern specific warning objects and use less classifier or neural network model, but the basic recognition factors may still be maintained without affecting the recognition accuracy. If the warning object exists in the images and the computer system is thus switched to the emergency state, the system resources occupied by the general recognition operations specific to the warning object are reduced, such that the advanced recognition operation can have sufficient system resources to provide the recognition result in real time. Moreover, in the embodiments of the disclosure, scenario factors including the person, the event, the location, the time, etc. are further analyzed to report more emergent scenarios, which thereby improves the reporting efficiency.

The foregoing description of the preferred embodiments of the disclosure has been presented for purposes of illustration and description. It is not intended to be exhaustive or to limit the disclosure to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the disclosure and its best mode practical application, thereby to enable persons skilled in the art to understand the disclosure for various embodiments and with various modifications as are suited to the particular use or implementation contemplated. It is intended that the scope of the disclosure be defined by the claims appended hereto and their equivalents in which all terms are meant in their broadest reasonable sense unless otherwise indicated. Therefore, the term “the disclosure”, “the present disclosure” or the like does not necessarily limit the claim scope to a specific embodiment, and the reference to particularly preferred exemplary embodiments of the disclosure does not imply a limitation on the disclosure, and no such limitation is to be inferred. The disclosure is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the disclosure. It should be appreciated that variations may be made in the embodiments described by persons skilled in the art without departing from the scope of the disclosure as defined by the following claims. Moreover, no element and component in the disclosure is intended to be dedicated to the public regardless of whether the element or component is explicitly recited in the following claims.

What is claimed is:

1. A resource arrangement method, adapted for a computer system, the resource arrangement method comprising:
obtaining a plurality of images captured by a plurality of image capturing apparatuses;
recognizing whether a warning object exists in the images of the image capturing apparatuses respectively through a plurality of recognition operations, wherein each of the recognition operations occupies a part of a system loading of the computer system; and
modifying the system loading used by the recognition operations if the warning object is recognized in at least one of the images.

2. The resource arrangement method according to claim 1, wherein the step of modifying the system loading used by the recognition operations comprises:
determining the images in which the warning object is not recognized as general images; and
reducing the system loading used by the recognition operations corresponding to the general images.

3. The resource arrangement method according to claim 2, wherein the step of reducing the system loading used by the recognition operations corresponding to the general images comprises:
reducing an image processing rate of the recognition operations corresponding to the general images.

4. The resource arrangement method according to claim 2, wherein the step of reducing the system loading used by the recognition operations corresponding to the general images comprises:
reducing an image resolution of the general images processed in corresponding recognition operation.

5. The resource arrangement method according to claim 2, wherein the step of modifying the system loading used by the recognition operations comprises:
determining the image in which the warning object is recognized as a focus image;
providing the system loading reduced from the general images to an advanced recognition operation; and
determining an interaction behavior between the warning object and an associated person in the focus image through the advanced recognition operation.

6. The resource arrangement method according to claim 1, wherein after the step of recognizing whether the warning object exists in the images of the image capturing apparatuses respectively through the recognition operations, the method further comprises:
allocating the system loading of the computer system to the recognition operations equally if the warning object is not recognized in any of the images of the image capturing apparatuses.

7. The resource arrangement method according to claim 1, wherein after the step of recognizing whether the warning object exists in the images of the image capturing apparatuses respectively through the recognition operations, the method further comprises:
switching to one of a normal state and an emergency state according to a recognition result of the recognition operations, wherein
in the normal state, the system loading used by the recognition operations is equaled; and
in the emergency state, the system loading used by the recognition operations in which the warning object is not recognized is reduced.

8. The resource arrangement method according to claim 5, wherein the step of recognizing whether the warning object exists in the images of the image capturing apparatuses respectively through the recognition operations comprises:
performing the recognition operations and the advanced recognition operation through an inference engine of artificial intelligence.

9. The resource arrangement method according to claim 5, wherein after the step of determining the interaction behavior between the warning object and the associated person in the focus image through the advanced recognition operation, the method further comprises:
reporting a recognition result of the advanced recognition operation.

10. A computer system, comprising:
an input apparatus, obtaining a plurality of images captured by a plurality of image capturing apparatuses;
a storage apparatus, recording the images of the image capturing apparatuses and a plurality of modules;
an image processor, operating an inference engine; and
a main processor, coupled to the input apparatus, the storage apparatus, and the image processor, and accessing and loading the modules recorded in the storage apparatus, the modules comprising and, wherein:
a plurality of basic recognition modules, performing a plurality of recognition operations through the inference engine to respectively recognize whether a warning object exists in the images of the image capturing apparatuses, wherein each of the recognition operations occupies a part of a system loading of the computer system; and
a load balancing module, modifying the system loading used by the recognition operations if the warning object is recognized in at least one of the images.

11. The computer system according to claim 10, wherein the load balancing module determines the images in which the warning object is not recognized as general images and reduces the system loading used by the recognition operations corresponding to the general images.

12. The computer system according to claim 11, wherein the modules further comprise:
a data modification module, reducing an image processing rate of the recognition operations corresponding to the general images.

13. The computer system according to claim 11, wherein the modules further comprise:
a data modification module, reducing an image resolution of the general images in corresponding recognition operation processing.

14. The computer system according to claim 11, wherein the load balancing module determines the image in which the warning object is recognized as a focus image and provides the system loading reduced from the general images to an advanced recognition operation, the modules further comprising:
an advanced recognition module, performing the advanced recognition operation through the inference engine to determine an interaction behavior between the warning object and an associated person in the focus image.

15. The computer system according to claim 10, wherein
the load balancing module equally allocates the system loading of the computer system to the recognition operations if the warning object is not recognized in any of the images of the image capturing apparatuses.

16. The computer system according to claim 10, wherein the modules further comprise:
an event feedback module, switching to one of a normal state and an emergency state according to a recognition result of the inference engine, wherein
in the normal state, the load balancing module allocates the system loading used by the recognition operations equally; and
in the emergency state, the load balancing module reduces the system loading used by the recognition operations in which the warning object is not recognized.

17. The computer system according to claim 14, wherein the modules further comprise:
a loading module, loading the basic recognition modules and the advanced recognition module in a booting process of the computer system.

18. The computer system according to claim 14, further comprising:
a warning apparatus, reporting a recognition result of the advanced recognition operation.

19. An image recognition method, comprising:
obtaining a plurality of images which are consecutively captured;
recognizing whether a warning object exists in the images;
determining a person associated with the warning object in the images if the warning object exists in the images; and
determining an interaction behavior between the person and the warning object in the images according to a temporal relationship of the images to determine a scenario corresponding to the images.

20. The image recognition method according to claim 19, wherein the step of determining the interaction behavior between the person and the warning object in the images according to the temporal relationship of the images comprises:
determining a movement path of the warning object along with the person according to the temporal relationship of the images.

21. The image recognition method according to claim 20, wherein the step of determining the interaction behavior between the person and the warning object in the images according to the temporal relationship of the images comprises:
determining whether the movement path in the scenario matches a reporting behavior; and
reporting the scenario if the movement path matches the reporting behavior.

22. The image recognition method according to claim 19, wherein the step of determining the interaction behavior between the person and the warning object in the images according to the temporal relationship of the images comprises:
determining whether the person matches a trusted person;
determining the person as a warning person if the person does not match the trusted person;
determining the interaction behavior between the warning person and the warning object; and
ignoring the interaction behavior between the trusted person and the warning object.

23. A computer system for image recognition, comprising:
an input apparatus, obtaining a plurality of images which are consecutively captured;
a storage apparatus, recording the images and a plurality of modules;
an image processor, operating an inference engine; and
a main processor, coupled to the input apparatus, the storage apparatus, and the image processor, and accessing and loading the modules recorded in the storage apparatus, the modules comprising:
a basic recognition module, recognizing whether a warning object exists in the images through the inference engine; and
an advanced recognition module, if the warning object exists in the images, the advanced recognition module determines a person associated with the warning object in the images through the inference engine, and determines an interaction behavior between the person and the warning object in the images according to a temporal relationship of the images to determine a scenario corresponding to the images.

24. The computer system for image recognition according to claim 23, wherein the advanced recognition module determines a movement path of the warning object along with the person according to the temporal relationship of the images.

25. The computer system for image recognition according to claim 24, wherein the advanced recognition module determines whether the movement path in the scenario matches a reporting behavior, and reports the scenario if the movement path matches the reporting behavior.

26. The computer system for image recognition according to claim 23, wherein the advanced recognition module determines whether the person matches a trusted person, if the person does not match the trusted person, the advanced recognition module determines the person as a warning person and determines an interaction behavior between the warning person and the warning object, and the advanced recognition module ignores the interaction behavior between the trusted person and the warning object.
